(19) United States
(12) Patent Application Publication
(10) Pub. No.: US 2006/0237421 A1
(43) Pub. Date: Oct. 26, 2006

(54) Heating apparatus and driving method therefor

(75) Inventors: Dong-woo Lee, Seoul (KR); Tae-gyu Kim, Hwaseong-si (KR); Jin-sung Lee, Seoul (KR); Bang-weon Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/397,604

(22) Filed: Apr. 5, 2006

(30) Foreign Application Priority Data
Apr. 7, 2005 (KR) 10-2005-0029019

(51) Int. Cl. F27B 9/06; F27D 11/00

(52) U.S. Cl. 219/388

(57) ABSTRACT

A heating apparatus and a method of driving the same. The heating apparatus includes: a heating plate on which an object to be heated is loaded and which is partitioned into a plurality of heating zones; a main heating apparatus that is placed on a lower portion of the heating plate and uniformly heats the entire heating plate; and a plurality of subheaters located below the heating plate and disposed to respectively correspond to the heating zones, such that each of the subheaters heats a corresponding one of the heating zones.

### CROSS-REFERENCE TO RELATED PATENT APPLICATION

This application claims priority from Korean Patent Application No. 10-2005-0029019, filed on Apr. 7, 2005, in the Korean Intellectual Property Office, the disclosure of which is incorporated herein in its entirety by reference.

### BACKGROUND OF THE INVENTION

1. Field of the Invention

The present invention relates to a heating apparatus and a method of driving the heating apparatus and, more particularly, to a heating apparatus and a method of driving the heating apparatus to heat uniformly the entire area of an object or to heat several regions of the object to different desired temperatures in a semiconductor manufacturing process.

2. Description of the Related Art

Generally, a semiconductor manufacturing process includes heating a wafer at a predetermined temperature such as baking a photoresist coated on a wafer, forming a thin layer on a wafer in a chemical vapor deposition (CVD) apparatus, and thermally treating a wafer such as baking a photoresist coated on a wafer.

FIG. 1 illustrates a conventional baking apparatus used in a semiconductor manufacturing process. FIG. 2 is a bottom view of a heating apparatus in FIG. 1. Referring to FIGS. 1 and 2, an upper cover 10 and a lower cover 20 form a chamber in which a baking process is performed. A heating apparatus 30 to heat a wafer W at a predetermined temperature is placed inside the chamber. A cooling chamber 40 to cool down the heated wafer W is placed below the heating apparatus 30.

The heating apparatus 30 includes a heating plate 31 on which a wafer W is loaded, and a plurality of heaters 32a, 32b, 32c, 32d, 32e, 32f, and 32g formed on a lower surface of the heating plate 31. The heating plate 31 is partitioned into heating zones corresponding to portions of the wafer. The heaters 32a, 32b, 32c, 32d, 32e, 32f, and 32g respectively correspond to each heating zone. The heaters 32a, 32b, 32c, 32d, 32e, 32f, and 32g are driven independently to heat the heating zones to desired temperatures.

In the above described configuration, to uniformly heat the entire wafer W loaded on an upper surface of the heating plate 31, the heaters 32a, 32b, 32c, 32d, 32e, 32f, and 32g heat each heating zone to the same temperature. In the case of a warped wafer, however, to uniformly heat the entire wafer W, the heaters 32a, 32b, 32c, 32d, 32e, 32f, and 32g should heat each of the heating zones to set temperatures. However, since in the conventional heating apparatus the heaters are formed in a layer on the lower surface of the heating plate 31, the heating zones must be always controlled together and when the intervals between the heaters are large, the temperatures between the heating zones may decrease.

### SUMMARY OF THE INVENTION

The present invention provides a heating apparatus including a main heating apparatus and a plurality of subheaters to heat uniformly the entire area of an object or to heat several regions of the object to desired temperatures and a method of driving the heating apparatus.

According to an aspect of the present invention, there is provided a heating apparatus comprising: a heating plate on which an object to be heated is loaded and which is partitioned into a plurality of heating zones; a main heating apparatus that is placed on a lower portion of the heating plate and uniformly heats the entire heating plate; and a plurality of subheaters located below the heating plate and disposed to respectively correspond to the heating zones, such that each of the subheaters heats a corresponding one of the heating zones.

The heating apparatus may further comprise a plurality of temperature sensors detecting a temperature of each of the heating zones.

The subheaters may be placed on a lower portion of the main heating apparatus and an insulating layer may be formed between the main heating apparatus and the subheaters.

The heating plate may be formed of ceramics or a metal.

According to an aspect of the present invention, there is provided a driving method for the heating apparatus comprising: setting a target temperature for each of the heating zones of the heating plate; driving the main heating apparatus to uniformly heat the entire heating plate; sensing an actual temperature of each of the heating zones of the heating plate and comparing it with the target temperature; and driving the subheaters corresponding to each of the heating zones having a temperature difference with respect to the actual temperature and the target temperature to heat the heating zones to the target temperatures.

The main heating apparatus may heat the heating plate to the lowest target temperature set for the heating zones.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional baking apparatus;

FIG. 2 is a bottom view of a heating apparatus in FIG. 1;

FIG. 3 is a cross-sectional view of a heating apparatus according to an exemplary embodiment of the present invention;

FIG. 4 is a bottom view of the heating apparatus in FIG. 3; and

FIG. 5 is a flowchart of a method of driving the heating apparatus in FIG. 3 according to an exemplary embodiment of the present invention.

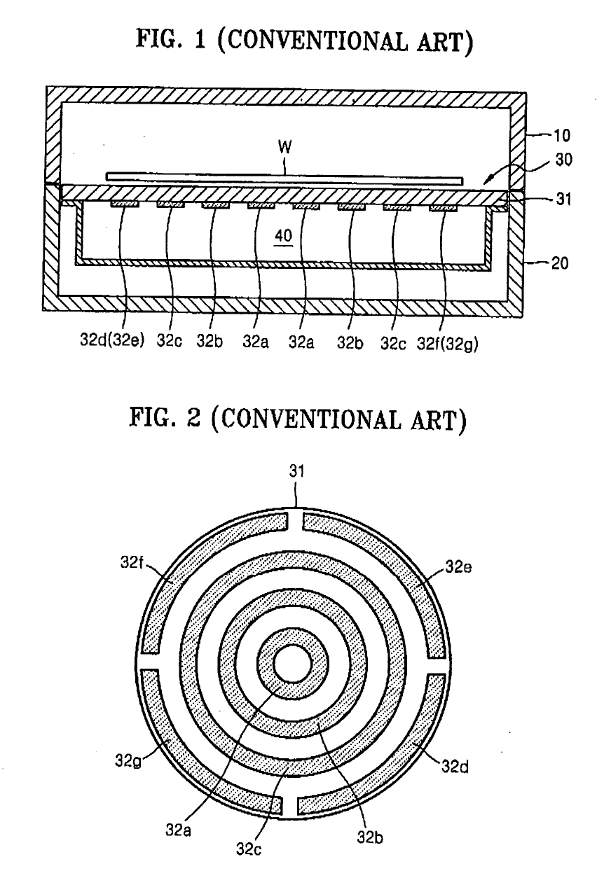

### DETAILED DESCRIPTION OF THE INVENTION

The present invention will now be described more fully with reference to the accompanying drawings, in which exemplary embodiments of the invention are shown. Like reference numerals in the drawings denote like elements, and thus their description will be omitted.

The present invention provides a heating apparatus used in a semiconductor manufacturing process to uniformly heat the entire area of a wafer or several regions of a wafer to desired temperatures so as to achieve a desired temperature distribution.

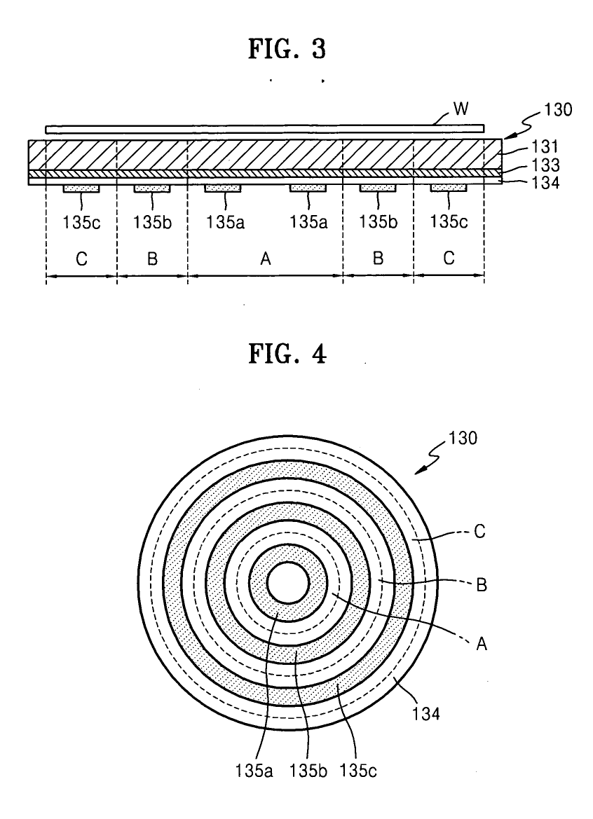

FIG. 3 is a cross-sectional view of a heating apparatus according to an embodiment of the present invention. FIG. 4 is a bottom view of the heating apparatus of FIG. 3.

Referring to FIGS. 3 and 4, a heating apparatus 130 includes a heating plate 131, a main heating apparatus 133, and a plurality of subheaters 135a, 135b, and 135c. The main heating apparatus 133 and the subheaters 135a, 135b, and 135c are stacked on a lower surface of the heating plate 131.

A wafer W to be heated is loaded on an upper surface of the heating plate 131. The heating plate 131 can be formed of ceramics or a strong metal. When the heating plate 131 is formed of a metal, an insulating layer 134 may be formed on a lower surface of the metal. The heating plate 131 is partitioned into a plurality of heating zones, that is, first heating zones A, second heating zones B, and third heating zones C, each corresponding to portions of the wafer W.

The main heating apparatus 133 is placed over the entire lower surface of the heating plate 131 and uniformly heats the whole heating plate 131. Also, an insulating layer 134 is formed on the lower surface of the main heating apparatus 133 to insulate the subheaters 135a, 135b, and 135c from the main heating apparatus 133.

The first subheaters 135a, the second subheaters 135b, and the third subheaters 135c are placed on a lower surface of the insulating layer 134. The first subheaters 135a, the second subheaters 135b, and the third subheaters 135c are placed, each corresponding to portions of the first, second, and third heating zones A, B, and C. The first subheaters 135a, the second subheaters 135b, and the third subheaters 135c are subheaters to heat the first, second, and third heating zones A, B, and C, respectively, to desired temperatures when the entire heating plate 131 is uniformly heated by the main heating apparatus 133. Also, though not shown in the drawings, temperature sensors are adhered to the first, second, and third heating zones A, B, and C to sense each temperature of the first, second, and third heating zones A, B, and C of the heating plate 131.

Here, although three heating zones A, B, and C corresponding to the three subheaters 135a, 135b, and 135c, respectively, are described, the number and formation of the heating zones and the subheaters can vary.

Furthermore, although the main heating apparatus 133 is placed above the subheaters 135a, 135b, and 135c, the main heating apparatus 133 can be also placed below the subheaters 135a, 135b, and 135c.

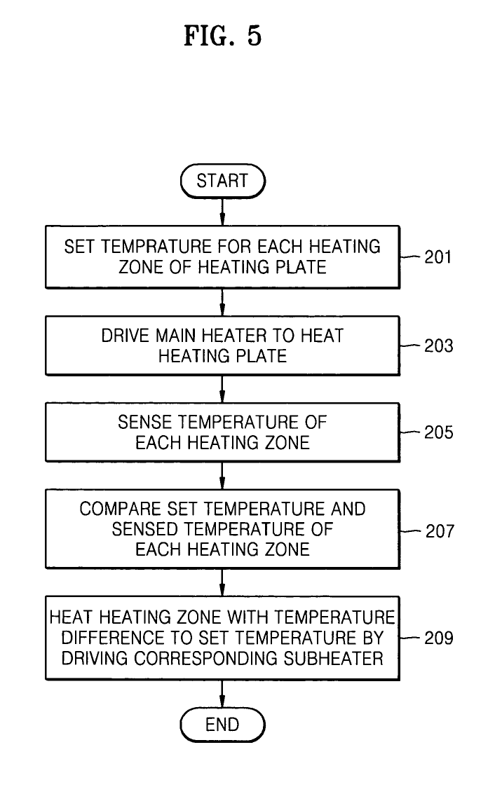

Hereinafter, a method of driving the heating apparatus will be described. FIG. 5 is a flowchart of a method of driving the heating apparatus according to an exemplary embodiment of the present invention. Referring to FIG. 5, a predetermined temperature may be set up for each of the first, second, and third heating zones A, B, and C of the heating plate 131 so that the wafer W is uniformly heated. Alternatively, each portion of the wafer W may be heated to different target temperatures. An example when the temperatures of the heating the heating zones A, B, and C are set to 100° C., 102° C., and 104° C., respectively, will be described below.

The main heating apparatus 133 (main heater) is driven to uniformly heat the entire heating plate 131 (operation 203). The main heating apparatus 131 may heat the heating plate 131 to 100° C., the lowest temperature of the temperatures set for the first, second, and third heating zones A, B, and C.

Next, temperature sensors sense the temperatures of the first heating zone, the second heating zone, and the third heating zone A, B, and C (operation 205). The sensed temperatures are compared with the set up temperatures (operation 207). In the present embodiment, temperature differences of 2° C. and 4° C. exist between the set temperatures and the sensed temperatures of the second heating zones B and the third heating zones C, respectively.

Finally, the second subheaters 135b and the third subheaters 135c are driven to increase the temperatures of the second heating zones B and the third heating zones C by 2° C. and 4° C., respectively. Accordingly, the first, the second, and the third heating zones A, B, and C maintain the temperatures 100° C., 102° C., and 104° C., which are set to heat the wafer W at desired temperatures (operation 209).

Thus, by using the method of driving the heating apparatus according to the present embodiment, a desired temperature distribution for each portion of the wafer W loaded on the upper surface of the heating plate can be obtained.

As described above, the heating apparatus of the present invention includes a main heating apparatus heating uniformly a heating plate, and a plurality of subheaters heating each heating zone of the heating plate. Thus, a desired temperature distribution for each portion of the wafer can be achieved during a semiconductor manufacturing process. Additionally, the heating apparatus of the present invention is particularly advantageous to heat a big-sized wafer, for instance, a wafer of 12 inches or more, which needs temperature control for each portion thereof.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A heating apparatus comprising:
a heating plate on which an object to be heated is loaded and which is partitioned into a plurality of heating zones;
a main heating apparatus that is placed on a lower portion of the heating plate and uniformly heats the entire heating plate; and
a plurality of subheaters located below the heating plate and disposed to respectively correspond to the heating zones, such that each of the subheaters heats a corresponding one of the heating zones.

2. The heating apparatus of claim 1, further comprising a plurality of temperature sensors detecting a temperature of each of the heating zones.

3. The heating apparatus of claim 1, wherein the subheaters are placed on a lower portion of the main heating apparatus.

4. The heating apparatus of claim 3, wherein an insulating layer is formed between the main heating apparatus and the subheaters.

5. The heating apparatus of claim 1, wherein the heating plate is formed of ceramics or a metal.

6. A driving method for the heating apparatus of claim 1, comprising:
setting a target temperature for each of the heating zones of the heating plate;
driving the main heating apparatus to uniformly heat the entire heating plate;
sensing an actual temperature of each of the heating zones of the heating plate and comparing it with the target temperature ; and
driving the subheaters corresponding to each of the heating zones having a temperature difference with respect to the actual temperature and the target temperature to heat the heating zones to the target temperature.

7. The driving method of 6, wherein the main heating apparatus heats the heating plate to the lowest target temperature set for the heating zones.
